(19) United States
(12) Patent Application Publication
(10) Pub. No.: US 2014/0333103 A1
(43) Pub. Date: Nov. 13, 2014

(54) SEAT ASSISTANCE SYSTEM, SEAT ASSISTANCE METHOD, AND SAFETY SEAT

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/139,785

(22) Filed: Dec. 23, 2013

(30) Foreign Application Priority Data
May 13, 2013 (TW) 102116846

(51) Int. Cl. B60N 2/427

(52) U.S. Cl. CPC B60N 2/42736
USPC 297/216.19

(57) ABSTRACT

A seat assistance method includes obtaining the inclined angle of a vehicle detected by a gyroscope. The method then determines if the obtained inclined angle of the vehicle is greater than a preset value. Next, the method controls a driving device to drive a seat to rotate towards a center of the vehicle when the obtained inclined angle of the vehicle is greater than the preset value.

### BACKGROUND

1. Technical Field

The present disclosure relates to seat assistance systems, and particularly, to a seat assistance system capable of automatically adjusting the incline of a seat, a related method, and a related safety seat.

2. Description of Related Art

In a conventional air or land vehicle, hereinafter referred to as a vehicle, a crash results in the occupants being thrown forward with great force against rigid structural members of the vehicle, frequently inflicting serious injury or death to one or more of the occupants. Accordingly, there is a need for a new seat assistance system and a safety seat.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a seat connected with a gyroscope and an angle detection unit, in accordance with an exemplary embodiment.

FIG. 2 is a schematic view showing the seat in a first state.

FIG. 3 is similar to FIG. 2, but showing the seat in a second state.

FIG. 4 is a schematic view showing the vehicle in an inclined state.

FIG. 5 is a flowchart of a seat assistance method, in accordance with an exemplary embodiment.

### DETAILED DESCRIPTION

The embodiments of the present disclosure are now described in detail, with reference to the accompanying drawings.

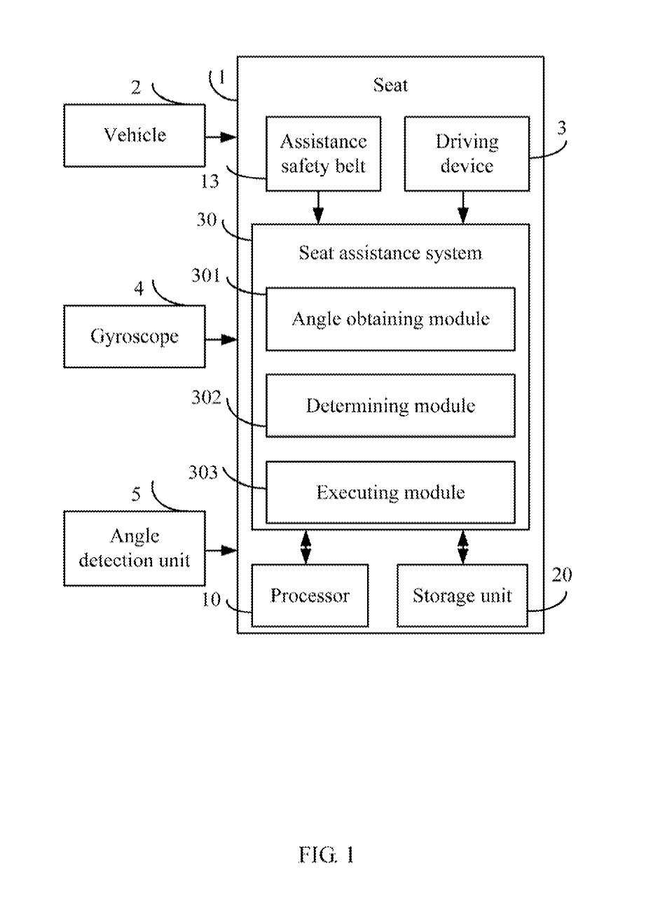

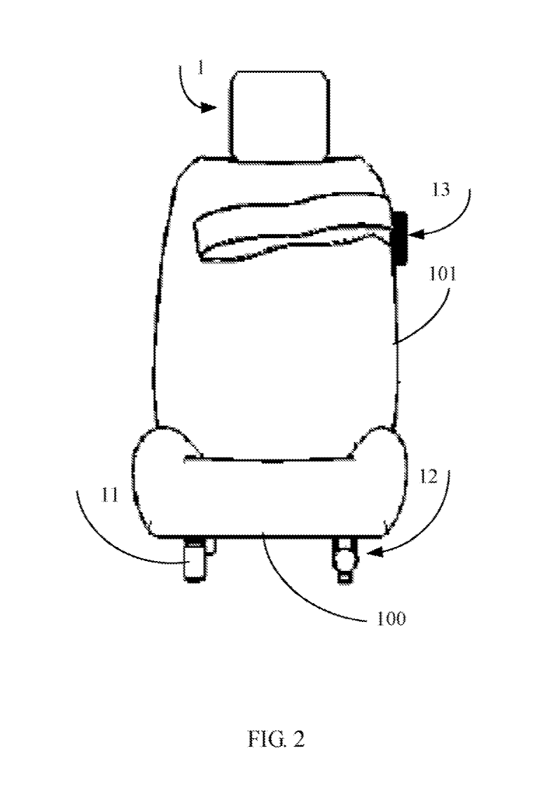

FIGS. 1-4 show an embodiment of a seat 1. The seat 1 is arranged in a vehicle 2. The seat 1 includes a driving device 3, at least one telescopic member 11, and at least one rotatable member 12. Each telescopic member 11 is arranged between a bottom 200 of the vehicle 2 and a base 100 of the seat 1. Each telescopic member 11 can be extended or can be compressed by the driving device 3 to vary in length. In the embodiment, each telescopic member 11 is, but is not limited to, a hydraulic pressure telescopic member or a threaded telescopic member. Each rotatable member 12 is arranged between the bottom 200 of the vehicle 2 and the base 100 of the seat 1. Each rotatable member 12 includes a fixed rod 121, a shaft 122, and a rotatable rod 123. A first end of the fixed rod 121 is fixed to the bottom 200 of the vehicle 2, and a second end of the fixed rod 121 is fixed to the shaft 122. A first end of the rotatable rod 123 is fixed to the shaft 122, and a second end of the rotatable rod 123 is fixed to the base 100 of the seat 1, thus the rotatable rod 123 is rotatably connected to the fixed rod 121 through the shaft 122.

In the embodiment, each telescopic member 11 is arranged on a side of the base 100 adjacent to a sidewall 201 of the vehicle 2, and each rotatable member 12 is arranged on an opposite side of the base 100 adjacent to a center of the vehicle 2. In the embodiment, the sidewall 201 of the vehicle includes a left and a right of the vehicle. In an alternative embodiment, the sidewall 201 of the vehicle includes a front and a rear of the vehicle. The base 100 of the seat 1 contacts the bottom 200 of the vehicle 2 through the telescopic members 11 and the rotatable members 12. The total number of the telescopic member 11 and the rotatable member 12 is equal to or greater than three. In this embodiment, two telescopic members 11 and two rotatable member 12 are employed. When each telescopic member 11 is in a natural state, the length of each telescopic member 11 is the same as the length of each rotatable member 12. Thus, when the telescopic members 11 are in the natural state, the seat 1 can be kept in a steady state with the cooperation of the telescopic members 11 and the rotatable members 12.

When each telescopic member 11 is extended or compressed by the driving device 3, the seat 1 is inclined, and each rotatable member 12 can rotate relative to the corresponding fixed rod 121, causing the seat 1 to rotate relative to the bottom 200 of the vehicle 2.

The seat 1 is further connected to a gyroscope 4. The gyroscope 4 detects an inclined angle of the vehicle 2. The seat 1 controls the driving device 3 to extend each telescopic member 11 when the inclined angle of the vehicle 2 is greater than a preset value, thus each rotatable member 12 rotates towards the center of the vehicle 2 relative to the corresponding fixed rod 121, and the seat 1 inclines towards the center of the vehicle 2. In the embodiment, the seat 1 includes a processor 10, a storage unit 20, and a seat assistance system 30. The seat assistance system 30 includes an angle obtaining module 31, a determining module 32, and an executing module 33. One or more programs of the above function modules may be stored in the storage unit 20 and executed by the processor 10. In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The angle obtaining module 31 obtains the inclined angle of the vehicle 2 detected by the gyroscope 4.

The determining module 32 determines whether or not the obtained inclined angle of the vehicle 2 is greater than the preset value.

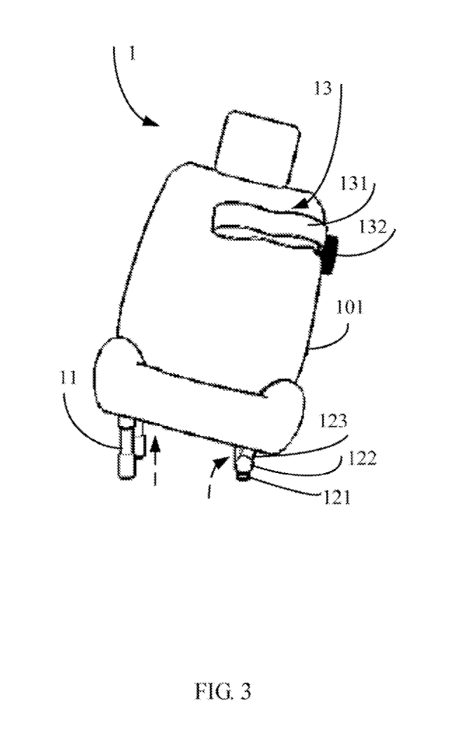

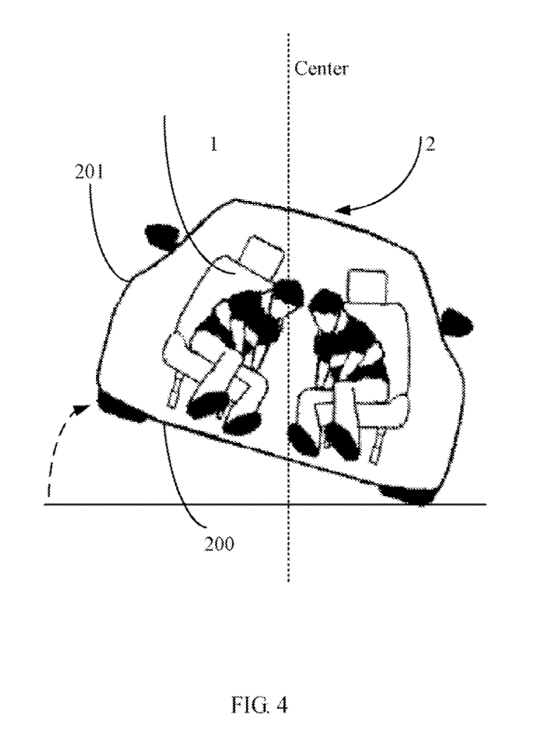

The executing module 33 controls the driving device 3 to extend each telescopic member 11 when the obtained inclined angle of the vehicle 2 is greater than the preset value, causing each rotatable rod 123 to rotate towards the center of the vehicle 2 relative to the corresponding fixed rod 121. Thus, the seat 1 inclines towards the center of the vehicle 2, and the occupants of the seat 1 inclines away from the rigid structural members (e.g., the door) of the vehicle 2 (see FIGS. 3-4). As shown in FIGS. 3-4, the broken lines respectively represent the movement direction and the inclined angle, and the dotted line represents the center of the vehicle 2.

In the embodiment, during each telescopic member 11 in an extended state, if the obtained inclined angle of the vehicle 2 becomes less than the preset value. The executing module 33 further controls the driving device 3 to compress each telescopic member 11, causing each telescopic member 11 to restore to the natural state, each rotatable rod 123 according restore to the natural state. Thus the base 100 of the seat 1 returns to the steady state.

In the embodiment, the seat 1 is further connected to an angle detection unit 5. The angle detection unit 5 detects the rotation angle of teach rotatable rod 123 relative to the corresponding fixed rod 121. The executing module 33 further obtains the rotation angle of each rotatable rod 123 relative to the corresponding fixed rod 121. In addition, control the driving device 3 to stop extending the telescopic member 11 when the obtained rotation angle of the rotatable rod 123 relative to the corresponding fixed rod 121 is equal to the obtained inclined angle of the vehicle 2. Thus the seat 1 can be kept in a steady state.

In the embodiment, the seat 1 further includes an assistance safety belt 13. The assistance safety belt 13 is arranged on the sidewall 101 of the seat 1 adjacent to the center of the vehicle 2. The assistance safety belt 13 includes a belt 131 and a retractor 132. The retractor 132 can be driven by the driving device 3 to retract the belt 131, and the belt 131 accordingly generates a pull to draw the occupant of the seat 1 towards the center of the vehicle 2. In this embodiment, the executing module 33 controls the driving device 3 to drive the retractor 132 to retract the belt 131 when the obtained inclined angle of the vehicle 2 is greater than the preset value, the occupant of the seat 1 can be drawn toward the center of the vehicle 2.

The position of each telescopic member 11 and each rotatable member 12 can be interchanged. The executing module 33 will not control the driving device 3 to extend each telescopic member 11 when the obtained incline angle of the vehicle 2 is greater than the preset value, but control the driving device 3 to compress each telescopic member 11, causing the seat 1 to inclines towards the center of the vehicle 2.

With such configuration, when a crash occurs, the seat 1 can automatically incline towards the center of the vehicle 2, with the occupant of the seat 1 away from the rigid structural members of the vehicle, avoiding serious injury or death to the occupant.

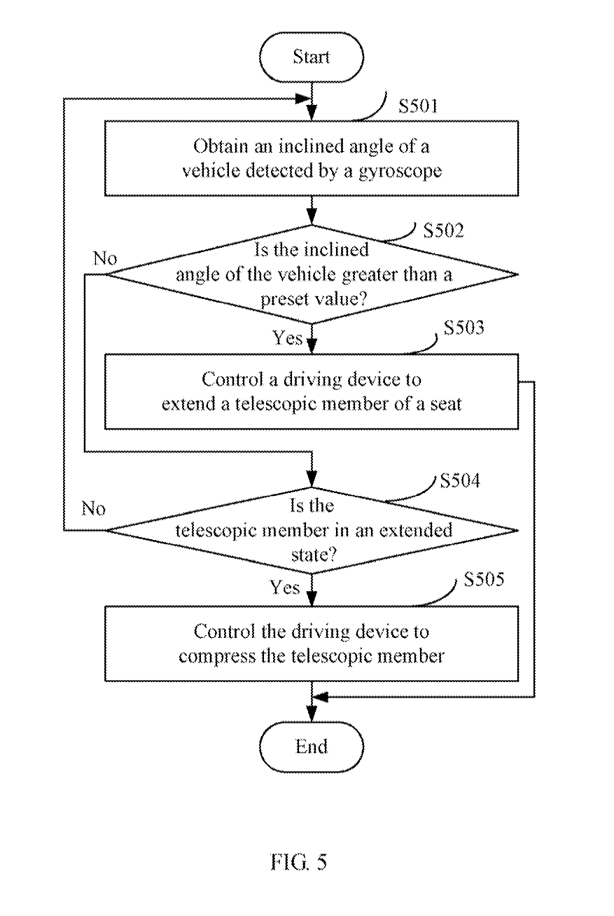

FIG. 5 shows a seat assistance method in accordance with an exemplary embodiment.

In step S501, the angle obtaining module 31 obtains an inclined angle of the vehicle 2 detected by the gyroscope 4.

In step S502, the determining module 32 determines whether or not the obtained inclined angle of the vehicle 2 is greater than the preset value. If the obtained inclined angle of the vehicle 2 is greater than the preset value, the procedure goes to step S503. If the obtained inclined angle of the vehicle 2 is less than the preset value, the procedure goes to step S504.

In step S503, the executing module 33 controls the driving device 3 to extend each telescopic member 11, causing each rotatable rod 123 to rotate towards the center of the vehicle 2 relative to the corresponding fixed rod 121, thus the seat 1 inclines towards the center of the vehicle 2.

In step S504, the determining module 32 determines whether or not each telescopic member 11 is in an extended state. If each telescopic member 11 is in the extended state, the procedure goes to step S505. If each telescopic member 11 is not in the extended state, the procedure goes to step S501.

In step S505, the executing module 33 controls the driving device 3 to compress each telescopic member 11, causing each telescopic member 11 to restore to the natural state, each rotatable rod 123 accordingly restore to the natural state, thus the base 100 of the seat 1 returns to the steady state.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A seat for being arranged in a vehicle, comprising:
a storage system;
a processor;
a driving device;
one or more programs stored in the storage system, executable by the processor, the one or more programs comprising:
an angle obtaining module operable to obtain the inclined angle of the vehicle detected by a gyroscope;
a determining module operable to determine whether or not the obtained inclined angle of the vehicle is greater than a preset value; and
an executing module operable to control the driving device to drive the seat to rotate towards a center of the vehicle when the obtained inclined angle of the vehicle is greater than the preset value.

2. The seat as described in claim 1, further comprising at least one telescopic member and at least one rotatable member; wherein each of the at least one telescopic member is to be arranged between a bottom of the vehicle and a base of the seat, each of the at least one telescopic member is capable of being extended or compressed by the driving device to vary in length; each of the at least one rotatable member is to be arranged between the bottom of the vehicle and the base of the seat, each of the at least one rotatable member comprises a fixed rod, a shaft, and a rotatable rod; a first end of the fixed rod is to be fixed to the bottom of the vehicle, and a second end of the fixed rod is connected to the shaft; a first end of the rotatable rod is fixed to the shaft, and a second end of the rotatable rod is fixed to the base of the seat; the executing module is operable to control the driving device to extend or compress each of the at least one telescopic member when the obtained inclined angle of the vehicle is greater than the preset value, each of the at least one rotatable rod accordingly rotates towards the center of the vehicle relative to the corresponding fixed rod.

3. The seat as described in claim 2, wherein each of the at least one telescopic member is arranged on a side of the base adjacent to a sidewall of the vehicle, and each of the at least one rotatable member is arranged on an opposite side of the base adjacent to a center of the vehicle; the executing module is operable to control the driving device to extend each of the at least one telescopic member when the obtained inclined angle of the vehicle is greater than the preset value, each of the at least one rotatable rod accordingly rotates towards the center of the vehicle relative to the corresponding fixed rod.

4. The seat as described in claim 2, wherein each of the at least one rotatable member is arranged on a side of the base adjacent to a sidewall of the vehicle, and each of the at least one telescopic member is arranged on an opposite side of the base adjacent to a center of the vehicle; the executing module is operable to control the driving device to compress each of the at least one telescopic member when the obtained inclined angle of the vehicle is greater than the preset value, each of the at least one rotatable rod accordingly rotates towards the center of the vehicle relative to the corresponding fixed rod.

5. The seat as described in claim 3, wherein the determining module is further operable to determine whether or not each of the at least one telescopic member is in an extended state when the obtained inclined angle of the vehicle becomes less than the preset value; the executing module is further operable to control the driving device to compress each of the at least one telescopic member when each of the at least one telescopic member is in the extended state, causing each of the at least one telescopic member to restore to the natural state, each of the at least one rotatable rod accordingly restores to the natural state.

6. The seat as described in claim 3, wherein the executing module is operable to obtain a rotation angle of each of the at least one rotatable rod relative to the corresponding fixed rod detected by an angle detection unit, and controls the driving device to stop extending each of the at least one telescopic member when the obtained rotation angle of each of the at least one rotatable rod relative to the corresponding fixed rod is equal to the obtained inclined angle of the vehicle.

7. The seat as described in claim 11, further comprising an assistance safety belt; wherein the assistance safety belt is arranged on the sidewall of the seat adjacent to the center of the vehicle; the assistance safety belt comprises a belt and a retractor; the retractor can be driven by the driving device to retract the belt, the belt accordingly generates a pull to draw an occupant of the seat towards the center of the vehicle; the executing module is operable to control the driving device to drive the retractor to retract the belt when the obtained inclined angle of the vehicle is greater than the preset value, the belt accordingly generates a pull to draw the an occupant of the seat towards the center of the vehicle.

8. A seat assistance method applied on a seat, the seat for being arranged in a vehicle, the method comprising:
obtaining the inclined angle of the vehicle detected by a gyroscope;
determining whether or not the obtained inclined angle of the vehicle is greater than a preset value; and
controlling a driving device to drive the seat to rotate towards a center of the vehicle when the obtained inclined angle of the vehicle is greater than the preset value.

9. The seat assistance method as described in claim 8, further comprising:
controlling the driving device to extend each of the at least one telescopic member when the obtained inclined angle of the vehicle is greater than the preset value, each of the at least one rotatable rod accordingly rotates towards the center of the vehicle relative to the corresponding fixed rod; each of the at least one telescopic member being arranged on a side of the base adjacent to a sidewall of the vehicle, and each of the at least one rotatable member being arranged on an opposite side of the base adjacent to the center of the vehicle.

10. The seat assistance method as described in claim 8, further comprising:
controlling the driving device to compress each of the at least one telescopic member when the obtained inclined angle of the vehicle is greater than the preset value, each of the at least one rotatable rod accordingly rotates towards the center of the vehicle relative to the corresponding fixed rod; each of the at least one rotatable member being arranged on a side of the base adjacent to a sidewall of the vehicle, and each of the at least one telescopic member being arranged on an opposite side of the base adjacent to the center of the vehicle.

11. The seat assistance method as described in claim 9, further comprising:
determining whether or not each of the at least one telescopic member is in an extended state when the obtained inclined angle of the vehicle becomes less than the preset value; and
controlling the driving device to compress each of the at least one telescopic member when each of the at least one telescopic member is in the extended state, causing each of the at least one telescopic member to restore to the natural state, each of the at least one rotatable rod accordingly restoring to the natural state.

12. The seat assistance method as described in claim 9, further comprising:
obtaining a rotation angle of each of the at least one rotatable rod relative to the corresponding fixed rod detected by an angle detection unit; and
controlling the driving device to stop extending each of the at least one telescopic member when the obtained rotation angle of each of the at least one rotatable rod relative to the corresponding fixed rod is equal to the obtained inclined angle of the vehicle.

13. The seat assistance method as described in claim 8, further comprising:
controlling the driving device to drive the refractor to retract the belt, the belt accordingly generates a pull to draw an occupant of the seat towards the center of the vehicle.
